(19) United States
(12) Patent Application Publication
(10) Pub. No.: US 2016/0250597 A1
(43) Pub. Date: Sep. 1, 2016

(54) A CALCIUM ION SEPARATION DEVICE

(71) Applicant: Zhiqian YE, Shanghai (CN)

(72) Inventor: Zhiqian YE, Shanghai (CN)

(21) Appl. No.: 14/761,005

(22) PCT Filed: Jul. 1, 2014
(86) PCT No.: PCT/CN2014/081409

§ 371 Date: Jul. 15, 2015

(30) Foreign Application Priority Data
Feb. 17, 2014 (CN) 201420067456.5

(51) Int. Cl. B01D 61/46

(52) U.S. Cl. CPC B01D 61/46

(57) ABSTRACT

The present invention disclosed a calcium ion separation device containing a direct-current power supply and multiple absorbing units, each absorbing unit is equipped with a separation chamber, electrode plates fir adsorbing ions, an anion-exchange membrane through which anions are passed and a cation-exchange membrane through which cations are passed, and wherein only monovalent cations and not divalent cations are passed through the cation-exchange membrane, the electrode plates are respectively disposed inside left and right side panels of the separation chamber and are respectively connected to the direct-current power supply to form positive and negative electrode plates, the anion-exchange membrane and the cation-exchange membrane are respectively disposed inside the positive and negative electrode plates, and one end of the separation chamber is a liquid inlet communicating with pending shell powders and the other end is a liquid outlet.

### BACKGROUND OF THE INVENTION

1. Field of the Invention

The present invention relates to a device for separating and extracting ions from solution, and more specially, to a calcium ion separation device.

2. Description of Related Art

With the improvement of people's living standard, calcium supplements have become daily selections for health life. Although shells are rich in calcium, calcium ions extracted from the shells only exist in solid powders of calcium carbonate, which arc difficult to be absorbed by the body and thus are reduced in commercial value. The utilization ratio of the shells will he greatly increased if calcium ions can be directly extracted from shell powders.

Ion exchange membranes are films that are made of polymers having ion permselectivity. Cation membranes are usually sulfonic acid type ion membranes and have fixed groups and dissociable ions, for example, in a sodium sulfonic acid type ion membrane, a sulfonic group is the fixed group and a sodium ion is the dissociable ion. The Cation membrane can be regarded as a kind of polyelectrolyte, of which the matrix is insoluble while the negatively charged sulfonic group attached to the matrix and the dissociable ion are hydrophilic and attracted to each other. Because the cation membrane is negatively charged, positively charged cations, which are dissociated into water by molecular force of water molecules, can pass through the cation membrane under an electric field created outside the membrane by energizing while anions cannot pass through the cation membrane due to repulsion between like charges, and therefore the cation membrane has permselectivity.

### BRIEF SUMMARY OF THE INVENTION

The technological problem solved by the present invention is to provide a calcium ion separation device for separating calcium ions from shell powders.

In order to solve the aforementioned technological problem, the present invention provides a calcium ion separation device containing a direct-current power supply and multiple absorbing units, wherein the term of multiple means one or more absorbing units are contained and each absorbing unit is equipped with a separation chamber, electrode plates for adsorbing ions, an anion-exchange membrane through which anions are passed and a cation-exchange membrane through which cations are passed, and wherein only monovalent cations and not divalent cations are passed through the eation-exchange membrane, the electrode plates are respectively disposed inside left and right side panels of the separation chamber and are respectively connected to the direct-current power supply to form positive and negative electrode plates, the anion-exchange membrane and the cation-exchange membrane are respectively disposed inside the positive and negative electrode plates, and more specifically, the anion-exchange membrane is disposed at the positive electrode plate side and the cation-exchange membrane is disposed at the negative electrode plate side, and one end of the separation chamber is a liquid inlet communicating with pending shell powders and the other end is a liquid outlet.

As a preferred embodiment, the multiple absorbing units are connected in series connection or parallel connection with each other, wherein the liquid outlet of a previous absorbing unit connects to the liquid inlet of a next absorbing unit in the series connection, however, the liquid outlets and liquid inlets of adjacent absorbing units are respectively connected with each other in the parallel connection.

The advantage of the present invention is that the device has a simple construction and an effect of energy conservation and environment protection. Calcium ions can be directly separated from shell powder solution and the calcium solution extracted has a high concentration and purity, and therefore the utilization ratio of the shell powders is greatly increased.

### BRIEF DESCRIPTION OF THE DRAWINGS

FIG. 1 is a schematic view of an absorbing unit contained in the calcium ion separation device of the present invention, wherein

1: separation chamber;

2: positive electrode plate

3: negative electrode plate

4: anion-exchange membrane

5: cation-exchange membrane

6: liquid inlet

7: liquid outlet

### DETAILED DESCRIPTION OF THE PREFERRED EMBODIMENTS

Hereinafter, the present invention will be described in detail with reference to the exemplary drawings. It should be understand that the following embodiment is intended to illustrate the present invention, and the technical solution is not limited by the embodiment.

First Embodiment

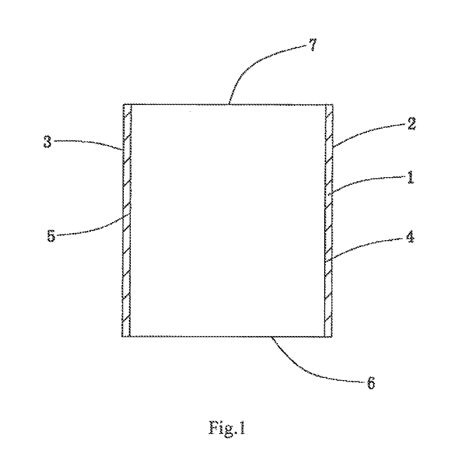

This embodiment provides calcium ion separation device containing a direct-current power supply and multiple absorbing units, wherein the term of multiple means one or more absorbing units are contained. As shown in FIG. 1, each absorbing unit is equipped with a separation chamber 1, electrode plates 2 and 3 for adsorbing ions, an anion-exchange membrane 4 through which anions are passed and a cation-exchange membrane 5 through which cations are passed, and wherein only monovalent cations and not divalent cations can pass through the cation-exchange membrane 5. The electrode plates 2 and 3 are respectively disposed inside lett and right side panels of the separation chamber 1 and are respectively connected to the direct-current power supply to form positive and negative electrode plates 2 and 3. The anion-exchange membrane 4 and the cation-exchange membrane 5 are respectively disposed inside the positive and negative electrode plates 2 and 3, and more specifically, the anion-exchange membrane 4 is disposed at the positive electrode plate 2 side and the cation-exchange membrane 5 is disposed at the negative electrode plate 3 side. One end of the separation chamber 1 is a liquid inlet 6 communicating with pending shell powders and the other end is a liquid outlet 7.

The multiple absorbing units are connected in series connection or parallel connection with each other, wherein the liquid outlet 7 of a previous absorbing unit connects to the liquid inlet 6 of a next absorbing unit in the series connection, however, the liquid outlets 7 and liquid inlets 6 of adjacent absorbing units are respectively connected with each other in the parallel connection.

When using the calcium ion separation device, shells are crushed into powders and then dissolved in water to obtain a shell powder solution. The shell powder solution is then flowed into the liquid inlet. The higher the concentration of the shell powder solution is, the higher the separation speed and the concentration of the separated calcium ions are.

The above content describes a preferred embodiment of the present invention. It should be indicated that a person of ordinary skill in the art, without departing from the concept of the present invention, may make many derivations or alternations, which should be deemed within the scope of the present invention.

What is claimed is:

1. A calcium ion separation device containing a direct-current power supply and multiple absorbing units, wherein the term of multiple means one or more absorbing units are contained, each absorbing unit is equipped with a separation chamber, electrode plates for adsorbing ions, an anion-exchange membrane through which anions are passed and a cation-exchange membrane through which cations are passed, and wherein only monovalent cations and not divalent cations are passed through the cation-exchange membrane, the electrode plates arc respectively disposed inside left and right side panels of the separation chamber and are respectively connected to the direct-current power supply to form positive and negative electrode plates, the anion-exchange membrane and the cation-exchange membrane. are respectively disposed inside the positive and negative electrode plates in which the anion-exchange membrane is disposed at the positive electrode plate side and the cation-exchange membrane is disposed at the negative electrode plate side, and one end of the separation chamber is a liquid inlet communicating with pending shell powders and the other end is a liquid outlet.

2. The calcium ion separation device as claimed in claim 1, characterized in that: the multiple absorbing units are connected in series connection or parallel connection with each other, wherein the liquid outlet of a previous absorbing unit connects to the liquid inlet of a next absorbing unit in the series connection, however, the liquid outlets and liquid inlets of adjacent absorbing units are respectively connected with each other in the parallel connection.
